(19) United States
(12) Patent Application Publication
(10) Pub. No.: US 2018/0150611 A1
(43) Pub. Date: May 31, 2018

(54) System for Practitioner-Patient Network Communicating Real-time Health Data and Prescription Calendars

(71) Applicants: Muhammad Ali Hasan, Newport Beach, CA (US); David MacLeod, Denver, CO (US)

(72) Inventors: Muhammad Ali Hasan, Newport Beach, CA (US); David MacLeod, Denver, CO (US)

(21) Appl. No.: 15/607,566

(22) Filed: May 29, 2017

Related U.S. Application Data
(60) Provisional application No. 62/314,492, filed on Mar. 29, 2016.

(51) Int. Cl. G06F 19/00; G06F 21/62

(52) U.S. Cl. CPC G06F 19/3418; G06F 21/6245; G06F 19/322; G06F 19/3456

(57) ABSTRACT

A system for practitioner-patient network communicating real-time health data, location and prescription calendar scheduling is provided that enables health care practitioners to monitor patients in real-time by patient location. Prescriptions may be generated, amended, renewed, and authorized in real-time over network. Data transmitted over network may be packaged with a unique patient identity parsed into the data stream whereby unique security protocols ensure point-to-point delivery.

### CROSS-REFERENCE TO RELATED APPLICATIONS

This nonprovisional application claims the benefit of provisional application No. 62/314,492 filed on Mar. 29, 2016

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### TO ALL WHOM IT MAY CONCERN

Be it known that we, Muhammad Ali Hasan and David MacLeod, both citizens of the United States, have invented new and useful improvements in a system for practitioner-patient network communicating real-time health data, location and prescription calendar scheduling as described in this specification, and that we claim the benefit of provisional application No. 62/314,492 filed on Mar. 29, 2016.

### COPYRIGHT NOTICE

Some portions of the disclosure of this patent document may contain material subject to copyright protection. The copyright owner has no objection to the facsimile reproduction by anyone of the patent document or ensuing disclosure as it appears on record at the Patent and Trademark Office, but otherwise reserves all copyright rights whatsoever.

### BACKGROUND OF THE INVENTION

The present system for practitioner-patient network communicating real-time health data, location and prescription calendar scheduling has been devised to enable real-time monitoring of patient health data across a practioner-patient network. Patient peripheral devices monitor patient location data via a GPS network and relay patient location to practioners operating a networked practitioner peripheral device. Practitioners are enabled selection of patients displayable as icons on an interactive map to view patient information, patient health data, and active prescription information. Practitioners can view a prescription calendar listing prescription schedules, and renew, alter, or generate prescriptions for patients digitally and share electronically.

Additionally, real-time health data is associable with patient identification data whereby patients' health is monitorable remotely, across network, in real-time. Inclusion of biometric devices implatable in, or wearable on or near a patient is contemplated as part of this disclosure whereby real-time health data is generable and communicable over network. Such health data is taken to include, as example, insulin, BAC, metabolite monitoring, urinalysis screening, in vivo measurements, analysis of sweat analytes, among other biometrics measurable by devices associated with a particular patient. Further, test results data is contemplated as uploadable to the network and associated with a particular patient by use of a unique patient identification data whereby real-time updates include test results data and other medical data. All data may be transferred between points of presence as a unique file type with a unique file naming extension which may automate default security handling separate from other traffic.

### FIELD OF THE INVENTION

The present invention relates to a system for practitioner-patient network communicating real-time health data, location and prescription calendar scheduling, and more particularly, to a system for practitioner-patient network communicating real-time health data, location and prescription calendar scheduling between users whereby a practitioner is enabled ascertainment of a patient health status and is able to effect generation, update, or renewal of relevant prescriptions or treatments peculiar to a particular patient determined electronically over network.

Additionally, practitioners may generate directions to patient locations by use of an interactive map whereon patient location data is displayable and updates and alerts regarding patient health statuses are likewise displayable associated with particular patients.

Monitoring of patient health status is contemplated in real-time generation of continuous measurements by integration with biometric devices worn, or used in vivo, by patients. Further, update to patient health data is effective by upload to network of medical test results, said results associable with particular patient identity data by use of unique patient identification data such as defining a patient account integrated into an electronic medical health system. All data used in the present network may be defined by a unique file type having a particular file name extension associated with all such transferable data, whereby default security protocols may be effected for secure and separate handling of all data traveling as part of the network.

### SUMMARY OF THE INVENTION

The present system for practitioner-patient network communicating real-time health data, location and prescription calendar scheduling has been devised to enable display of real-time health data of patients across a user network linking practitioners and patients into a shared user space. Real-time test results, and other health data, may be displayable on an interactive map whereon patient location is determinable. Practitioner selection of a relevant patient shown upon the map reveals health data for that patient. Use of in vivo and wearable biometric devices to provide real-time continuous health-data is also contemplated as part of this invention, including use of intravenous, hypodermic, suppository, oral cavity, and biometric devices capable of sensing indicator characteristics indicative of patient health or reading of vital signs or relaying other biometric or physiological data.

The present system for practitioner-patient network communicating real-time health data, location and prescription calendar scheduling, therefore, includes a patient peripheral device and a practitioner peripheral device disposed in networked communication. The patient peripheral device is disposed in wireless communication with a Global Positioning System (“GPS”) whereby real-time location data is determinable for said patient peripheral device. Location data is thus communicable over network to a central server whereby patient location is displayable graphically for a unique patient identity, said identity matched to the instant patient peripheral device. A graphical user interface may therefore display patient location as an icon, or other graphical element, as part of an interactive, selectable map, displayable on the practitioner peripheral device. Practitioners may thus locate patients upon the interactive map and ascertain real-time health data by selection of each patient upon the map, as will be described subsequently.

The term “peripheral device”, as used herein throughout, is taken to include all computing devices connectable in network with a central server and may include smart phones, tablets, handhelds, laptops, and desktop computers, as well as wearable electronic and biometric devices capable of relaying information, or rendering information sensible to another such peripheral device, whereby real-time health data is communicable across network for display between end users.

The patient peripheral device is matched to a unique patient identity. Test results performed for a particular patient, and associated with the unique patient identity, are therefore communicable into the network from point of presence whereat results are uploaded to the network. Tests results data is thereby communicable to populate a unique patient account with relevant results data. Selection of any patient displayed on the interactive map by a practitioner interacting with a networked practitioner peripheral therefore enables display of health data—including test results data associated with the patient identity. A practitioner can thus ascertain patient health status and vital signs by selection of a patient displayed by patient location upon the interactive map.

Further, in vivo or wearable biometric devices are contemplated as operating in sensible contact or communication with the patient and with the patient peripheral device whereby homeostasis and/or vital signs as well as other baseline medical data are communicable in real-time over the network. Such in vivo or biometric data is taken to include patient pulse, blood pressure, blood sugar level, hormone levels, blood concentration of metabolites, metabolites in perspiration, bioelectric fields, blood alcohol content, presence or absence of other indicators (such as, for example, enzymes, cardiovascular analytes, among other such biochemical and physical indicators) and biometrical determinations measurable by a device implanted in, or worn by or proximal, a patient.

Emergency response is thereby facilitated should a patient's biometric data determine emergent need of medical care. Since the location of the patient is communicated in real-time in conjunction with biometric data and test data, as case may be, emergency response may be directed to the patient location without need of determining the whereabouts of the patient in question. This saves time and resources by enabling rapid deployment of an emergency response to the patient location.

All data communicated between patient and practitioner peripherals, and any central server or intermediary system necessary for storage and/or communication of relevant health data, may be effected as a unique file type, having a distinct and unique file extension. This file type may enable default handing across network and effect secure transfer protocol specific to the file type. All transfer protocol is enabled with mind to HIPPA compliance, and other State and Federal security requirements. The unique file type is devised for specific use with the present system for practitioner-patient network communicating real-time patient health data, location and prescription calendar scheduling whereby the protocol for running the file type is coded into the present system, thereby limiting access to data encoded by the file type absent use of the programming specifically devised for operating the transfer protocol herein disclosed.

Thus has been broadly outlined the more important features of the present system for practitioner-patient network communicating real-time health data, location and prescription calendar scheduling so that the detailed description thereof that follows may be better understood and in order that the present contribution to the art may be better appreciated.

For better understanding of the system for practitioner-patient network communicating real-time health data, location and prescription calendar scheduling, its operating advantages and specific objects attained by its uses, refer to the accompanying drawings and description.

### BRIEF DESCRIPTION OF THE DRAWINGS

### Figures

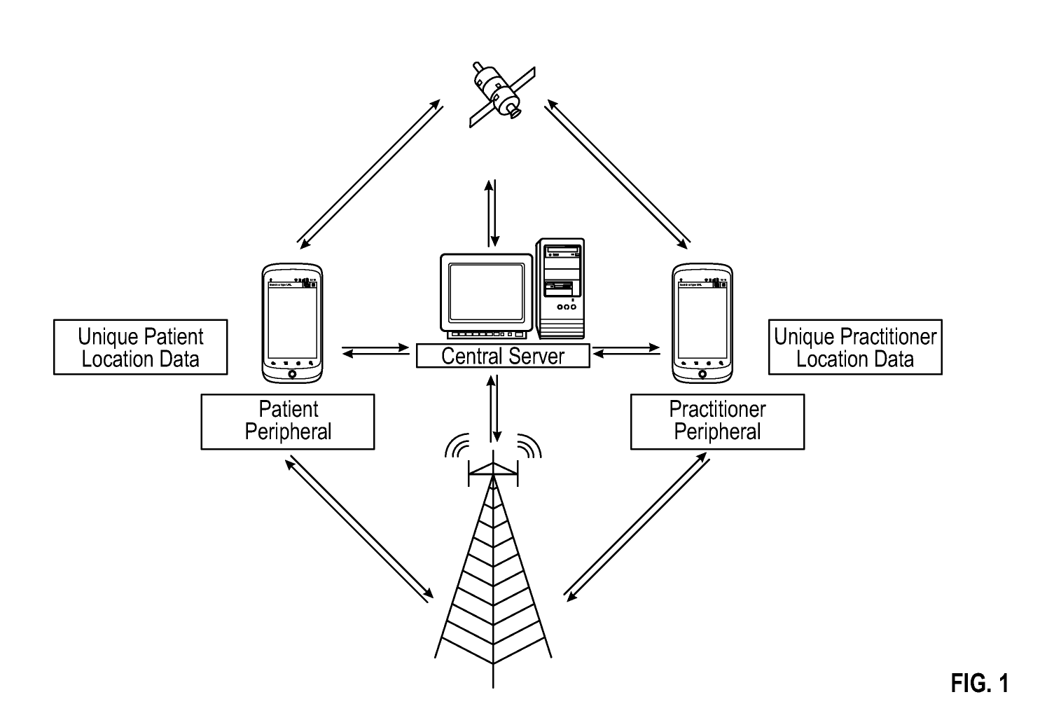

FIG. 1 is a diagrammatic view of an example embodiment of a practitioner-patient network communicating real-time health results and prescription calendars between end-user peripheral devices.

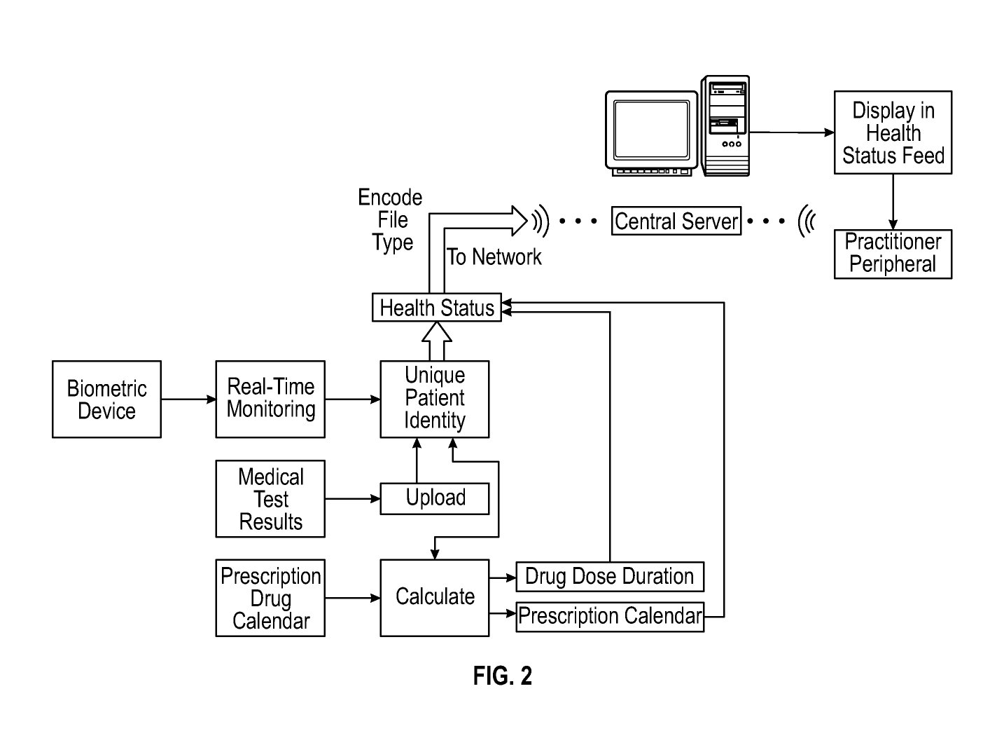

FIG. 2 is a diagrammatic view of generation and transmission of health status data over network to a practitioner peripheral device.

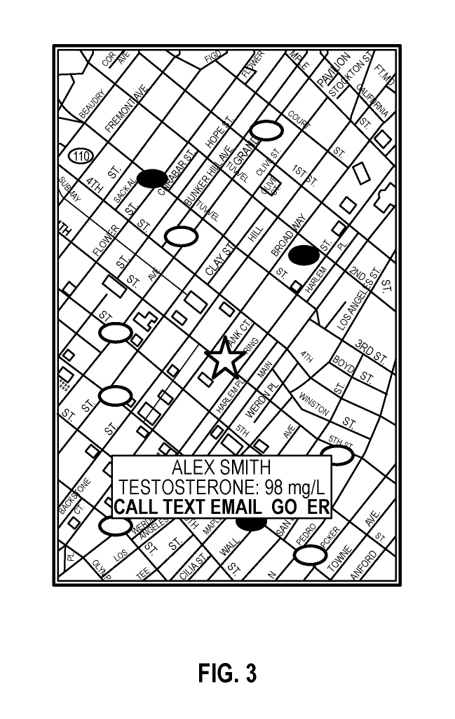

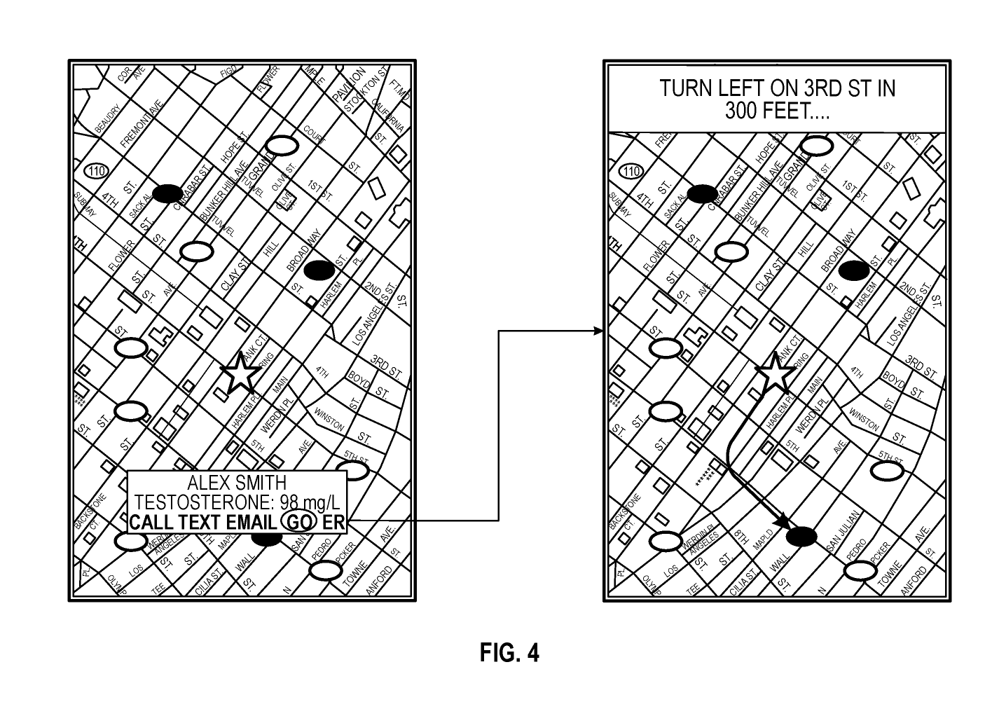

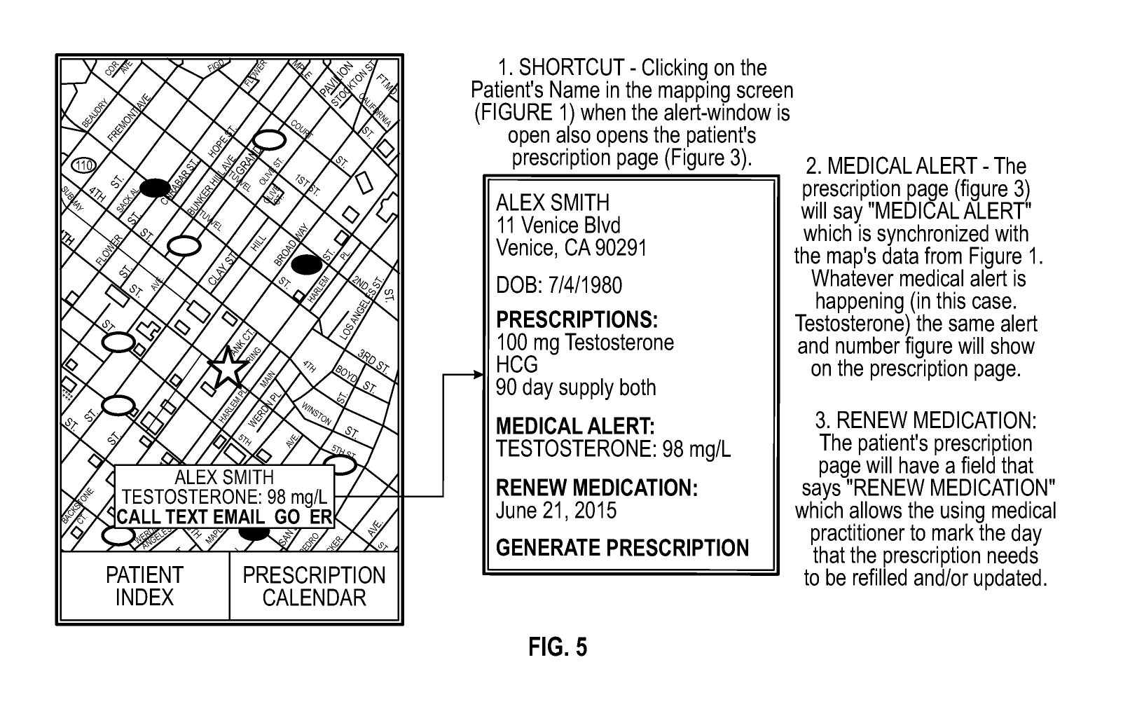

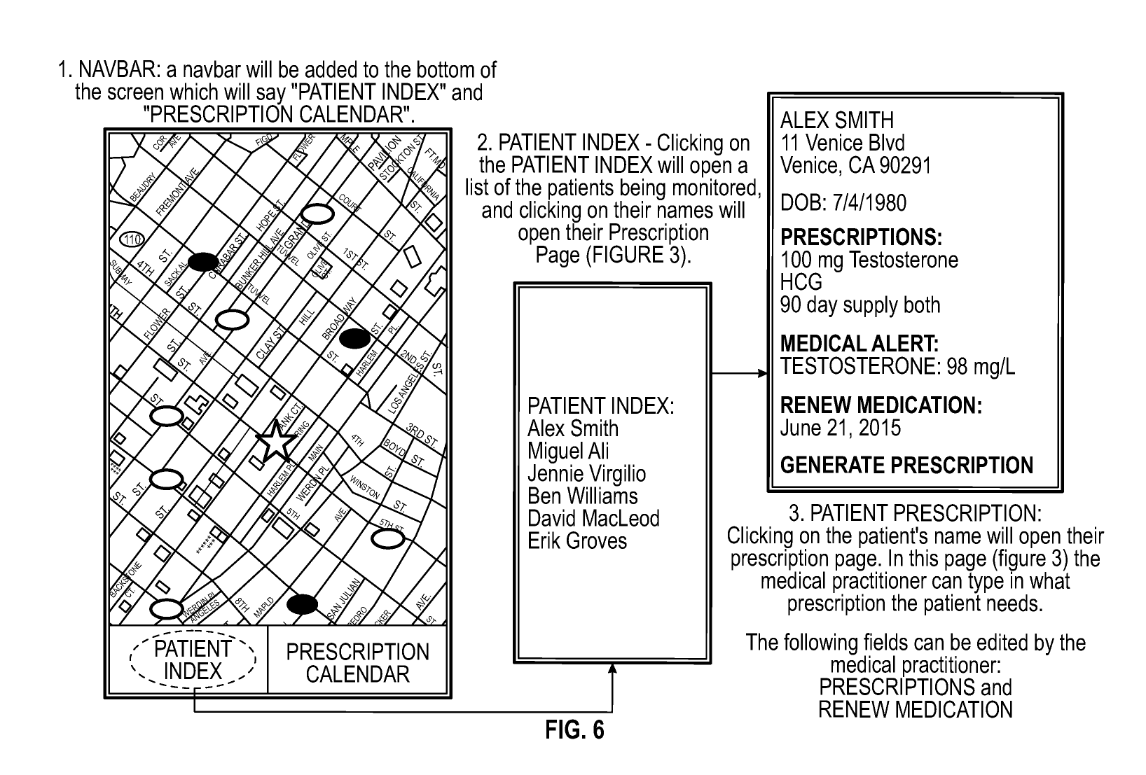

FIG. 3 is a screenshot view of an example embodiment of the interactive scalable map upon a practitioner peripheral showing a feed summary of pertinent health-data for a particular patient.

FIG. 4 is a screenshot view of an example embodiment of a practitioner selecting and opening an associated directions view screen directing the practitioner to the patient location.

FIG. 5 is a screenshot view of an example embodiment of practitioner selection of a particular patient displayed on the interactive map to effect opening of a patient information screen displaying health data pertinent to the selected patient including relevant prescription data.

FIG. 6 is a screenshot view of an example embodiment of a patient index selectable upon the practitioner peripheral device wherein patent health data is accessible by selection of a displayed patient name listed as part of the patient index.

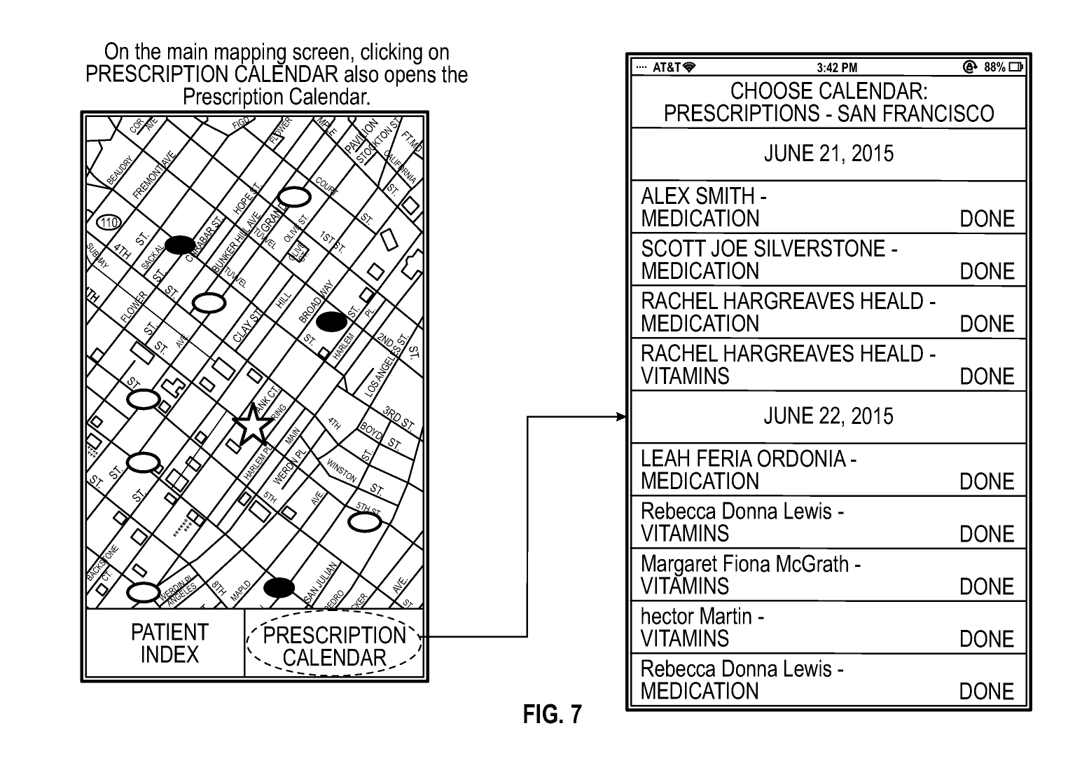

FIG. 7 is a screenshot view of an example embodiment a practitioner selection of a prescription calendar wherein selection effects presentation of a prescription calendar showing scheduled prescriptions for individual patients.

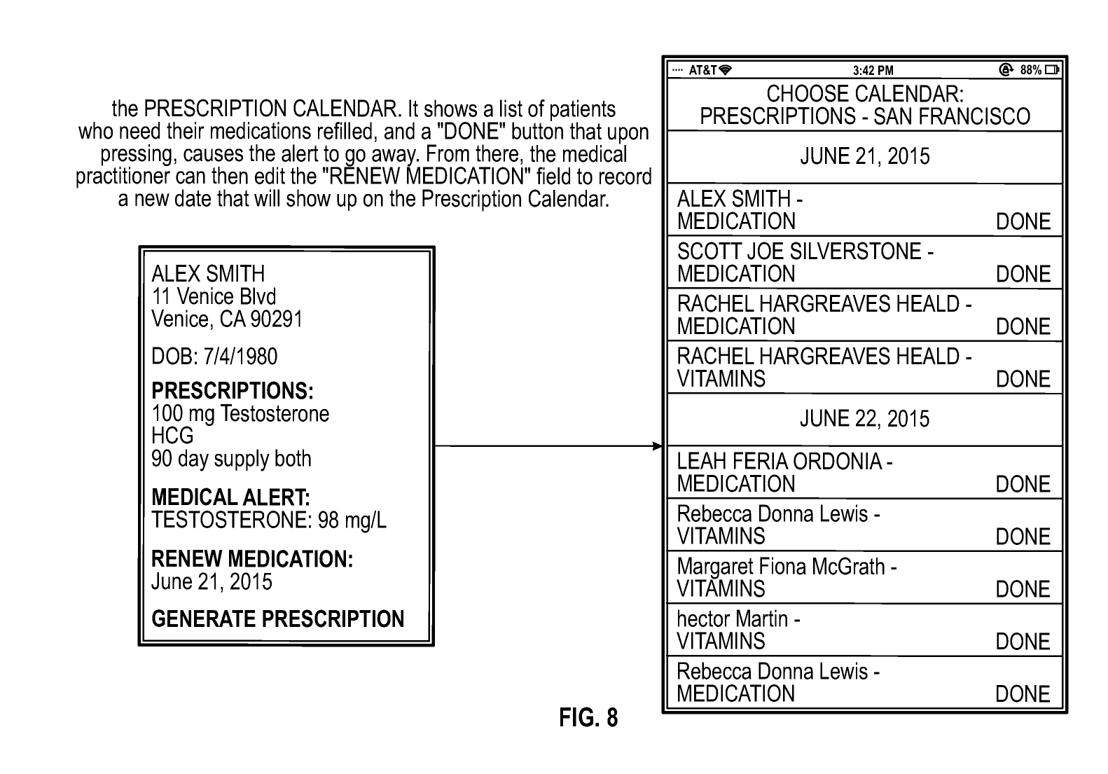

FIG. 8 is a screenshot view of an example embodiment of an alert prompt wherein the prescription calendar is openable from an alert prompt displayable on screen to refill or alter a current prescription.

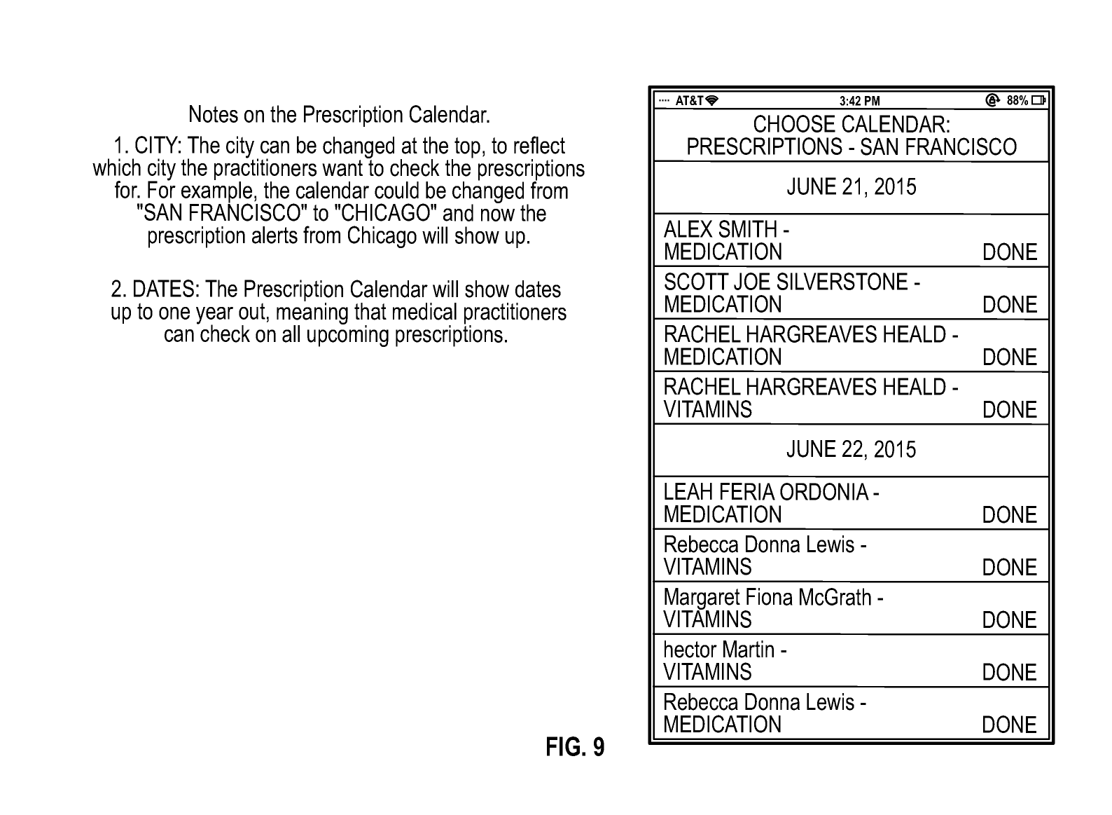

FIG. 9 is a screenshot view of an example embodiment wherein examples enabling navigation of the calendar are enabled, such as effective selection of an appropriate region or date range.

FIG. 10 is a screenshot view of an example embodiment of generating a prescription for a particular patient upon the practitioner peripheral.

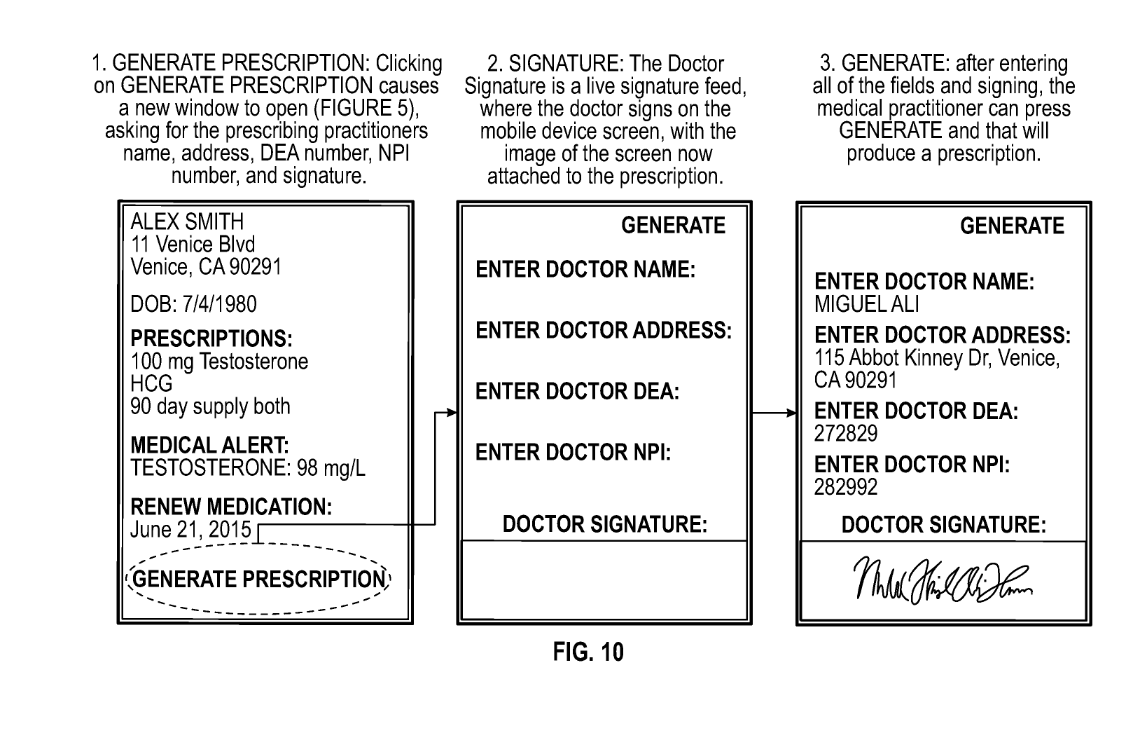

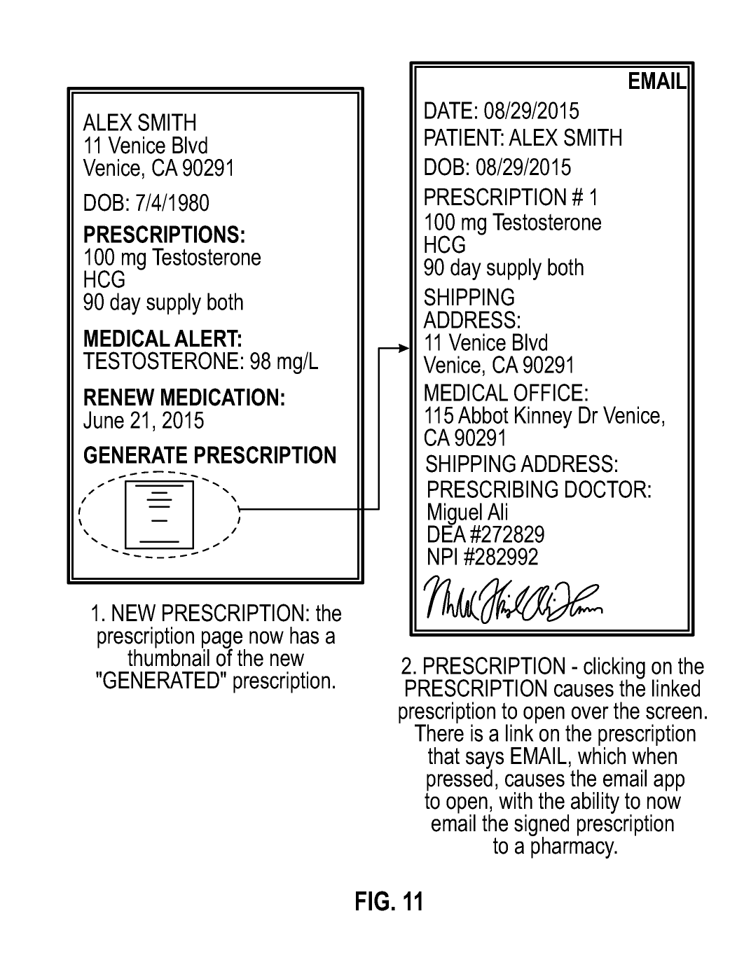

FIG. 11 is a screenshot view of an example embodiment of generating a prescription thumbnail for sending to a pharmacy.

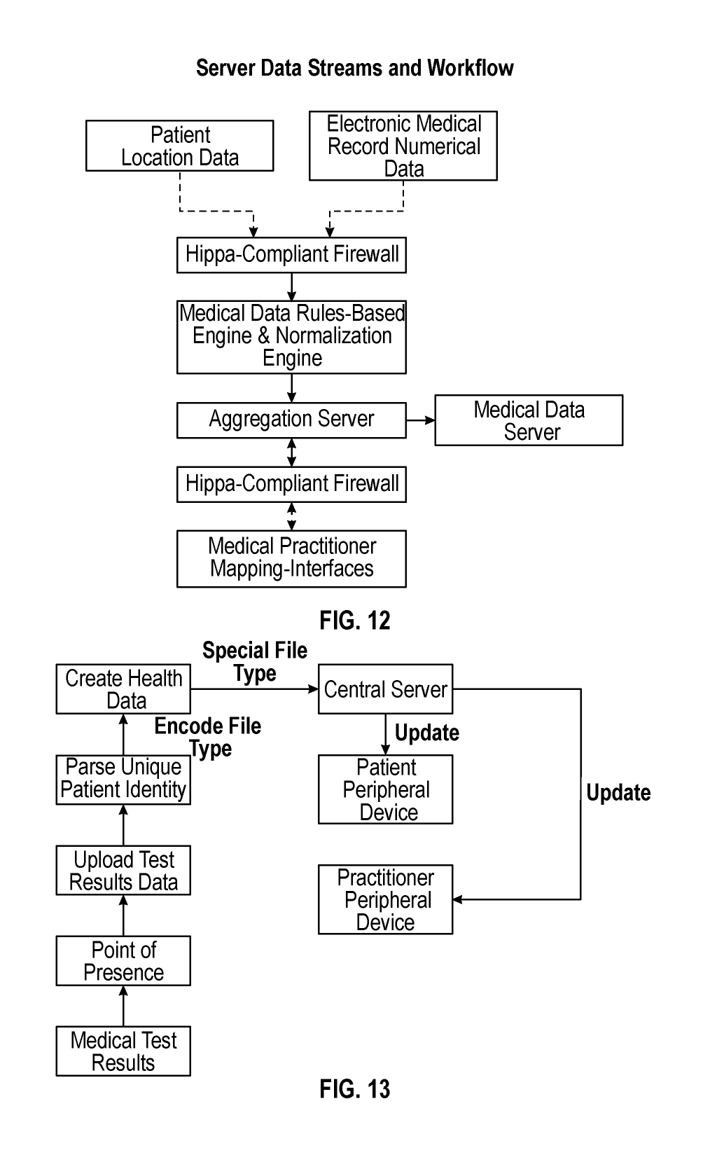

FIG. 12 is an example embodiment of a flow diagram illustrating the streams of data comprising a network of patient and practitioner peripherals.

FIG. 13 is a diagrammatic view of generating health status data for transmission over network.

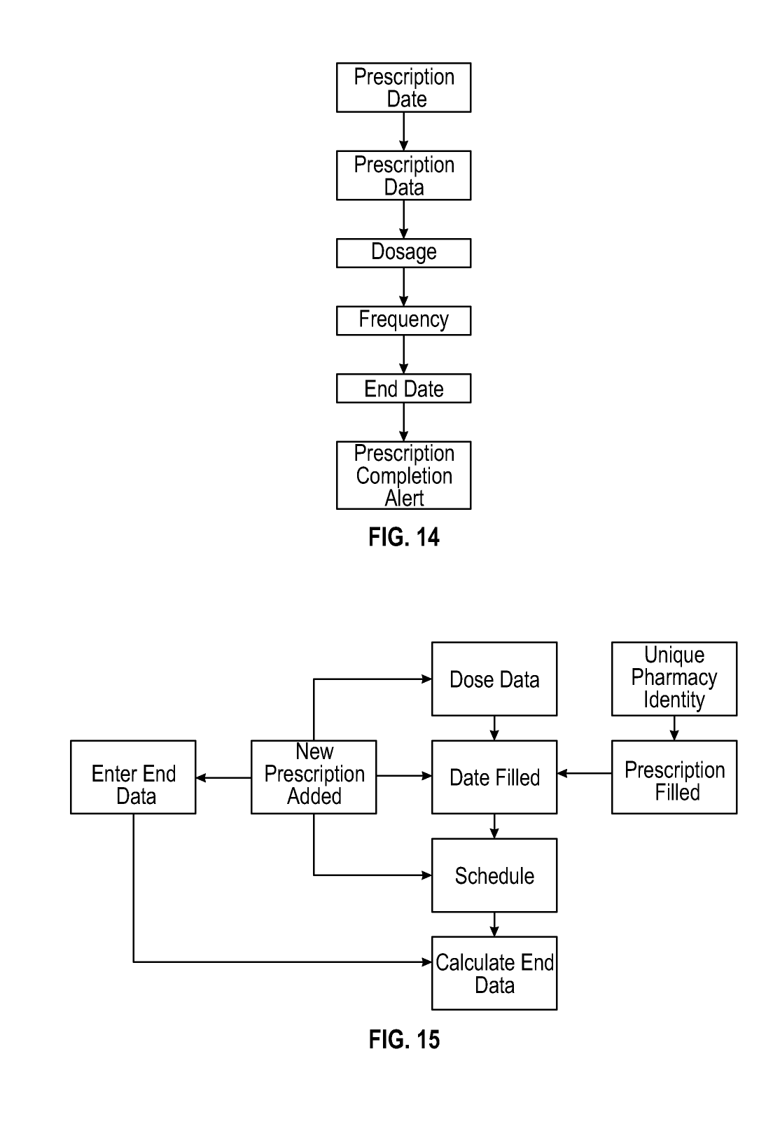

FIG. 14 is a diagrammatic view of calculating a prescription calendar and pushing an alert notification to an end user.

### DETAILED DESCRIPTION OF THE DRAWINGS

With reference now to the drawings, and in particular FIGS. 1 through 14 thereof, example of the instant system for practitioner-patient network communicating real-time health data, location and prescription calendar scheduling employing the principles and concepts of the present system for practitioner-patient network communicating real-time health data, location and prescription calendar scheduling and generally designated by the reference number 10 will be described.

Referring to FIGS. 1 through 14 a preferred embodiment of the system for practitioner-patient network communicating real-time health data, location and prescription calendar scheduling 10 is illustrated.

FIG. 1 illustrates a diagrammatic view of an example embodiment depicting a patient peripheral device disposed in network with a practitioner peripheral device via management at a central server. A unique patient identity is associated with the patient peripheral device whereby unique patient location data is determinable by coordination within a Global Positioning System (“GPS”). A unique patient location data is thereby generable and communicable to the practitioner peripheral device for display upon an interactive map, as will be described subsequently.

FIG. 2 illustrates a diagrammatic view of an example embodiment of the generation of a patient health status data, communicable over network and associated with the unique patient identity whereby display of a patient health status upon the practitioner peripheral is determinable. The patient health status may include data such as sensed vital signs or, for example, another analyte such as blood alcohol content, for example, or a concentration of testosterone, or other hormone, or analyte for which reading in a patient is desirable. Heath status data is generable from biometric monitoring of the patient whereby real-time health status data is communicable over network. Such heath status data may be periodically transmitted over network in discrete time frames, such as every two minutes for example, or at another interval where more appropriate to the analyte being measured per the particular patient and that particular patient's health status data currently relevant to examination at hand.

Thus a biometric device, disposed in sensible contact with the patient, may provide for real-time monitoring and reporting over network to push results into a health status feed for each patient, viewable upon the practitioner peripheral associated with the unique patient identity. Health status data, therefore, includes health data from real-time monitoring via biometric devices disposed in sensible contact with the unique patient, including for example, wearable devices, implanted devices, and other such devices as are capable of recording biometric data from a person. Additional data generable as health status data include medical test result data and prescription calendar data.

When health status data signals to the practitioner peripheral a health status data indicative of an emergent need for medical care, emergency response may be rapidly deployable to the precise patient location to administer treatment. Real-time monitoring of location data and patient health status data enables a coordinated emergency response in those situations where an emergency response is determined to be necessary. Further, the present system may issue an alarm signal devised to alert a practitioner that vital signs of a particular patient have fallen beneath a particular threshold whereby emergent action may be required to save the patient's life.

Medical test result data is uploadable to network and associable with a particular unique patient identity by assignment of the data to a particular unique patient identity at time of test taking or when uploading the results. Thus particular test results may be associated to the particular unique patient identity and thereby pushed to the unique patient health status feed displayable upon the practitioner peripheral.

The prescription calendar data automates communication of expired prescriptions to the practitioner peripheral for renewal or cancellation, as desired. The prescription calendar data calculates remaining life of a prescription based on a prescribed dose and the quantity of medicine dispensed when filling the prescription. Thus, for example, a prescribed daily dosage rendered relative a quantity of drug dispensed when filling the prescription enables calculation of a prescription end date. When the date is reached, a prescription alert may be pushed to the practitioner peripheral (see also FIG. 14).

A prescription calendar may likewise expire by action of a specific end date, enterable at time of authoring the prescription, whereby the prescription automatically expires as of that date. A prescription calendar may be set for multiple refills over a period of time, and thereby auto-renew at the practitioner's behest. In some cases the practitioner will be prompted to authorize an automated renewal of a prescription by alert push notification upon the practitioner peripheral. As shown in FIGS. 10 and 11, means for generating a prescription and renewing prescriptions digitally is effective as part of the present system. Authorizing of prescriptions may be managed by timestamp from the practitioner peripheral, which is also associable with a unique practitioner identity, or by manual signature captured through the practitioner peripheral device. A particular digital file may likewise be employed to signify authorization of a prescription, such as an electronic fingerprint file, for example, renewable periodically through board-certified channels. Additional means of effecting authorization by a particular practitioner, such as dermatoglyph scanning, for example, or other biometric determination, are contemplated as part of this disclosure.

FIG. 3 illustrates an example embodiment of an interactive map displayable upon a practitioner peripheral device. The practitioner location is shown centrally in the map, and indicated by an icon—a pentagram in the present example, however any distinguishing icon is contemplated wherein the practitioner location is readily differentiable from patient locations. Patient locations are displayed upon the map from patient location data provided through an integrated Global Positioning System (“GPS”) disposed in networked communication with each participating patient peripheral. Patients are distinguishable as separate, unique icons and may include indicia differentiating a patient health status. Patient health status may be generable from real-time monitoring health data fed to the system or, alternately, generated from uploaded medical test results, or calculated relative a schedule or timeline such as, for example, a prescription or drug schedule. Patient health status may be signaled to a user by a visual cue, such as a change in indicia associated with each unique icon, such indicia including, for example, color change, flashing or intermittent display, among other potential means of signaling a status update to a practitioner viewing the interactive map.

In the example depicted in FIG. 3, a patient feed summary window active. The patient feed summary window includes a generated synopsis of relevant patient health data (such as a level of testosterone, as shown here, among potential other health data including, for example, BAC, insulin levels, levels of metabolite, urinalysis metabolites, etc.). The patient summary feed is contemplated to be adaptable to populate synopses relevant to the particular health data corresponding to a particular patient, and may auto-populate a feed field with data extracted from a particular field accessible through a patient health data screen, as will be described subsequently.

FIG. 4 illustrates an example embodiment of the interactive map once a particular patient has been selected by a practitioner and directions to the patient location are thereby generable to guide the practitioner to the patient. In the instant example, the practitioner has selected a “go” link, accessible through the patient summary feed window active for a particular patient, whereby a directions view is effected with an appropriate route between the practitioner and patient concurrently displayed. It should be recognized that the patient summary feed may act like an alert, whereby automated display of alerts as summary feeds enables practitioner awareness of a particular patient's health data and may thereby make an in-person call. Additional means of effecting activity of the directions view is contemplated as part of this provisional application for letters patent, including, for example, selection of a patient icon, as case may be.

FIG. 5 illustrates an example embodiment of a practitioner selection effecting activity of a patient information screen. The patient information screen includes relevant patient data—such as contact information, date of birth, as well as relevant prescription data and a generate prescription button. Selection of the generate prescription button may effect opening of a prescription entry screen comprising fields wherein the practitioner is enabled to generate a prescription for the particular patient, authorize the prescription, and forward it on to relevant parties. A renew prescription feature enables automated regeneration of an authorized prescription at the appropriate date.

FIG. 6 illustrates a practitioner selection of a patient index, presenting an alternate means of browsing and selecting participating patients in the present network. Selection of a patient identity from the patient index may effect activity of the patient information screen and prescription generation means.

FIG. 7 illustrates practitioner selection of a prescription calendar from the interactive map view whereby a prescription calendar is openable with each relevant patient and associated prescription displayed as part of an interactive timeline. A practitioner may, therefore, browse active prescriptions by location or date, as preferred, and effect interaction with relevant patent information screens and prescriptions rendered accessible by the prescription calendar.

FIG. 8 illustrates update of the prescription calendar for a particular practitioner when a prescription is updated, renewed, or generated by interaction through the patient information screen. Thus the prescription calendar is auto-populated by data generated at creation of an updated, renewed, or new prescription for each relevant patient in question.

FIG. 9 illustrates interaction with the prescription calendar to sort displayed data by relevant location or a preferred date range, whereby a practitioner is enabled alternate means of viewing prescriptions. Additional means of sorting the prescription data are contemplated, including by drug, by treatment, by patient, and so on.

FIG. 10 illustrates generation of a prescription for a particular patient, wherein a practitioner signature is required to authorize the prescription. Prescription generation may involve activity of an intermediate prescription generation screen comprising data fields by which prescription information is enterable and authenticated by a practitioner authorization field—here exemplified by addition of a practitioner signature. However, biometric scan, dermatoglyphs, or chirography, among other examples, may likewise be used to auto-fill or authenticate the authorization field whereby third-parties are enabled comprehension of legitimacy regarding any prescription. Prescriptions are thence trackable and associable with a generating practitioner and associated patient whereby monitoring of prescriptions, patients, and practitioners is automatically effective.

FIG. 11 illustrates generation of a prescription thumbnail for forwarding and transferring to third parties, such as particular pharmacies or patients. In the example embodiment illustrated in FIG. 10, a newly generated or updated prescription for a particular patient has been effected through the practitioner peripheral and a thumbnail image of the prescription has been embedded in the patient information screen for selection by the practitioner for expedited sharing with third-parties where relevant (such as with pharmacists, for example).

FIG. 12 illustrates a data flow across the network. Patient location data is routed through secure network protocol through a medical data rules-based engine and a normalization engine to an aggregation server where it is transferable to a medical data server. Unique patient identities are associable with relevant patient location data, and an electronic medical account number, usable to interface the patient location data with additional patient health data, is associable with the patient location data. Relevant patient location data and health data is thus relayable for display on a practitioner peripheral as part of an interactive map whereby the practitioner is enabled selection of patient icons to ascertain real-time health data updates and prescription monitoring.

All such data transferable across network may be effected as a unique file type differentiating the data from other data handled during transfer. The unique file type may include a unique file name extension, whereby all data for transfer as part of the instant practitioner-patient network communicating real-time health data and prescription calendars is automatically identifiable and potentially subjected to default and distinct transfer protocol effecting secure transfer protocol by necessity.

FIG. 13 illustrates a diagrammatic view of an example embodiment of test results data being uploaded to network with encoding into a special file type communicable to the central server. The central server then pushes the received test results data to both the patient peripheral device associated with the unique patient identity with which the medical test results data is associated, and likewise to the practitioner peripheral device.

FIG. 14 illustrates a diagrammatic view of an example embodiment of a prescription calendar calculation whereby a prescription end date is automatically determinable. In the present example a dosage and frequency input enable determination of expiration of the prescription whereby an automated renewal notification—a prescription completion alert—is communicable to the practitioner peripheral device.

FIG. 15 illustrates a diagrammatic view of an example embodiment of a prescription calendar calculating the prescription end date. A practitioner may enter the prescription into the practitioner peripheral device to an associated unique patient identity. The dose data and schedule as entered is thence usable to automate calculation of the expiration of the prescription from the date the prescription was filled. Confirmation of filling the prescription may require a third data input into the system from an authorized pharmacy identity whereby the prescription associated to the unique patient identity is accessible and confirmable at the pharmacy by automated distribution of the prescription from the practitioner peripheral to a particular pharmacy (or group of pharmacies) at time of generation.

The unique practitioner identity, unique patient identity, and unique pharmacy identity enable requisite tracking of prescriptions across network and each data transferred may be logged and stored to memory for later review.

Further, for patients requiring delivery of medication, the present system for patient-practitioner network communicating real-time patient health data, location and prescription calendar scheduling, the transmission of real-time location data enables delivery of prescriptions to the patient location to coincide with the expiration of a prescription as displayed by means of the prescription calendar.

What is claimed is:

1. A system for practitioner-patient network communicating real-time health data, location and prescription calendar scheduling using encrypted data transmission comprising:
on at least a patient peripheral device in operation in the possession of a unique patient having a unique patient identity and a practitioner peripheral device in operation in the possession of a unique practitioner having a unique practitioner identity, wherein said patient peripheral device and practitioner peripheral device are disposed in networked communication:
determining real-time location data from the patient peripheral device as part of a Global Positioning System;
communicating said real-time location data over network to a central server;
updating display upon an interactive map to display real-time location data for each unique patient identity upon the practitioner peripheral device; and
communicating a patient health status for each unique patient identity displayable upon the interactive map, each said patient health status generable by:
real-time monitoring of health data readable from the patient by action of biometric devices disposed in sensible communication with the patient;
upload of medical test results to the network; and
calculation of an end date relative a schedule entered as part of a prescription calendar;
to wherein patient location data displays an icon upon the interactive map and a patient health status is determinable by a practitioner when consulting the interactive map.

2. The system for practitioner-patient network communicating real-time health data, location and prescription calendar scheduling of claim 1 wherein the patient health status is displayable as part of an openable patient feed summary window, said patient feed summary window providing read display of a synopsis of relevant patient health data and access to a selectable menu.

3. The system for practitioner-patient network communicating real-time health data, location and prescription calendar scheduling of claim 2 further comprising a method of digital prescription generation, said method comprising the steps of:
presenting an intermediate prescription generation screen when a link in the patient information screen is selected, said intermediate prescription generation screen having data fields for entry of prescription data peculiar to the unique patient identity;
authenticating the prescription by action of capturing a signature upon the peripheral device and alternatively by biometric scan of a dermatoglyph of the practitioner;
pushing the prescription to the patient peripheral and an associated unique pharmacy identity; and
storing the prescription to the central server associated between the practitioner and the patient and the unique pharmacy identity;
wherein prescriptions are trackable and associable between a generating practitioner and an associated patient, whereby generation of prescriptions and monitoring of prescriptions, patients, and practitioners, is effected automatically.

4. The system for practitioner-patient network communicating real-time health data, location and prescription calendar scheduling of claim 3 wherein the generated prescription appears as a thumbnail image on the patient information screen of the practitioner peripheral whereby selection of the thumbnail enables sharing with third-parties and selected unique pharmacy identities.

5. The system for practitioner-patient network communicating real-time health data, location and prescription calendar scheduling of claim 4 wherein the unique patient identity is enumerated by an electronic medical account number.

6. The system for practitioner-patient network communicating real-time health data, location and prescription calendar scheduling of claim 5 wherein the real-time health data is packaged as a unique file type.

7. The system for practitioner-patient network communicating real-time health data of claim 5 wherein fulfillment of a prescription enables calculation of a prescription end date, said fulfillment of the prescription associated as filled by timestamp of the unique pharmacy identity noted to fill the prescription assigned the unique patient identity.

8. The system for practitioner-patient network communicating real-time health data of claim 5 wherein the networked communication between the patient and practitioner peripheral devices comprises exchange of data transferred encoded as a unique file-type whereby read access to the unique file-type data requires operation of a corresponding application.

9. A system for practitioner-patient network communicating real-time health data between a patient peripheral device and a practitioner peripheral device communicating over network, said system comprising:
a unique patient identity associated to a unique patient peripheral device;
a unique practitioner identity associated to a unique practitioner peripheral device;
a central server disposed in networked communication with each of the unique patient peripheral device and the practitioner peripheral device;
at least one biometric sensor disposed in operational communication with the patient peripheral device, said at least one biometric sensor disposed in sensible contact with an associated patient whereby real-time health data is generable for communication over network;
determination of unique patient location data via coordination of the patient peripheral device operating as part of a Global Positioning System over network;
display of the unique patient location data as an identifying icon upon an interactive scalable map displayable upon the practitioner peripheral device, said identifying icon selectable to reveal health data associated with the unique patient identity;
uploading a prescription generated upon the practitioner peripheral device associated with the unique patient identity, said prescription sharable with a unique pharmacy identity;
recording fulfillment of the prescription by the unique pharmacy identity, said recordation including a date of fulfillment data and a schedule of prescribed dose data;
calculating a prescription end date from the date of fulfillment data and the schedule of prescribed dose data; and
pushing a prescription completion alert to the practitioner peripheral when the prescription end date arrives;
wherein patient location data displays as an identifying icon upon the interactive map, a patient health status is determinable by a practitioner when consulting the interactive map, and prescriptions are generable for fulfillment for the unique patient identity by the unique pharmacy identity.

10. The system for practitioner-patient network communicating real-time health data of claim 9 wherein the networked communication between the patient and practitioner peripheral devices comprises exchange of data transferred encoded as a unique file-type whereby read access to the unique file-type data requires operation of a corresponding application.
